(19) United States
(12) Patent Application Publication
(10) Pub. No.: US 2010/0057869 A1
(43) Pub. Date: Mar. 4, 2010

(54) Event Driven Email Revocation

(76) Inventors: Angelos Stavrou, Springfield, VA (US); Sushil Jajodia, Oakton, VA (US); Lei Zhang, Fairfax, VA (US)

Correspondence Address: GEORGE MASON UNIVERSITY;OFFICE OF TECHNOLOGY TRANSFER, MSN 5G5, 4400 UNIVERSITY DRIVE, FAIRFAX, VA, 22030, US

(21) Appl. No.: 12/548,175

(22) Filed: Aug. 26, 2009

Related U.S. Application Data
(63) Continuation of application No. 61/092,162, filed on Aug. 27, 2008.

(51) Int. Cl. G06F 15/16

(52) U.S. Cl. 709/206

(57) ABSTRACT

An email revocation in which transmitted email can be recalled before a recipient is able to read the transmitted email is provided. An event server stores a transmitted email for a given time period or until being retrieved by a receiving email client. If the given time period expires or the email is recalled, the receiving email client is unable to retrieve the email.

### CROSS-REFERENCE TO RELATED APPLICATIONS

This application claims the benefit of U.S. Provisional Application No. 61/092,162, filed Aug. 27, 2008, and having Attorney Docket No. GMU-09-003P, which is hereby incorporated by reference in its entirety.

### STATEMENT REGARDING FEDERALLY SPONSORED RESEARCH OR DEVELOPMENT

This invention was made with government support under grants CT-0716567, CT-0627493, IIS-0242237 and IIS-0430402 awarded by the National Science Foundation. The U.S. government has certain rights in this invention.

### BRIEF DESCRIPTION OF THE SEVERAL VIEWS OF THE DRAWINGS

The general inventive concept will become more fully understood from the detailed description given herein below and the accompanying drawings, wherein like elements are represented by like reference numerals, which are given by way of illustration only and thus are not limiting of the general inventive concept and wherein:

FIG. 1 illustrates an email transmission and revocation system according to an example embodiment.

FIG. 2 illustrates a method for transmitting and recalling email messages at a sending email proxy according to an example embodiment.

FIG. 3 illustrates a method for transmitting and recalling email messages at an event server according to an example embodiment.

FIG. 4 illustrates a sending email proxy according to an example embodiment.

FIG. 5 illustrates an event server according to an example embodiment.

### DETAILED DESCRIPTION OF EMBODIMENTS

For many people email has become the predominant communication medium for both business and personal communications. Email's role as conduit naturally leads to its use for many different tasks including highly sensitive and private messages.

As the use of email increases, the amount of messages on which a particular user must act increases. With only little time to parse through many email messages in a given user's email inbox, users have become more prone to inadvertently transmitting email messages to one or more users who are not the intended recipients. Users may periodically wish to recall or revoke transmitted email messages.

Example embodiments provide an email revocation system in which transmitted email message(s) may be recalled before a recipient is able to read the transmitted email. Example embodiments also provide methods and apparatuses for revoking transmitted emails.

It is noted that example embodiments are described as apparatuses depicted as block diagrams and processes or methods depicted as flowcharts. Although the flowcharts describe the operations as sequential processes, many of the operations may be performed in parallel, concurrently or simultaneously. In addition, the order of operations may be re-arranged. The processes may be terminated when their operations are completed, but may also have additional actions not included in the figure(s). The processes may correspond to methods, functions, procedures, subroutines, subprograms, etc.

Methods and apparatuses illustrated by the flow charts and block diagrams discussed below may be implemented by hardware, software, firmware, middleware, microcode, hardware description languages (which may be implemented, for example, by field programmable gate arrays (FPGAs)), or any combination thereof. When implemented in software, firmware, middleware or microcode, the program code or code segments to perform the necessary tasks may be stored in a machine or computer readable medium such as a storage medium. A processor(s) may perform the necessary tasks.

The flow charts and block diagrams may represent structured processors or processing devices. If implemented in a processor, application specific integrated circuit (ASIC) or other processing device or computer, example embodiments may transform these apparatuses or machines into structured, application specific or special purpose machines (e.g., processors, computers, processing devices, etc.), rather than general purpose machines.

As disclosed herein, the term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information. The term “computer-readable medium” may include, but is not limited to, portable or fixed storage devices, optical storage devices, and various other mediums capable of storing and/or containing instruction(s) and/or data.

A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

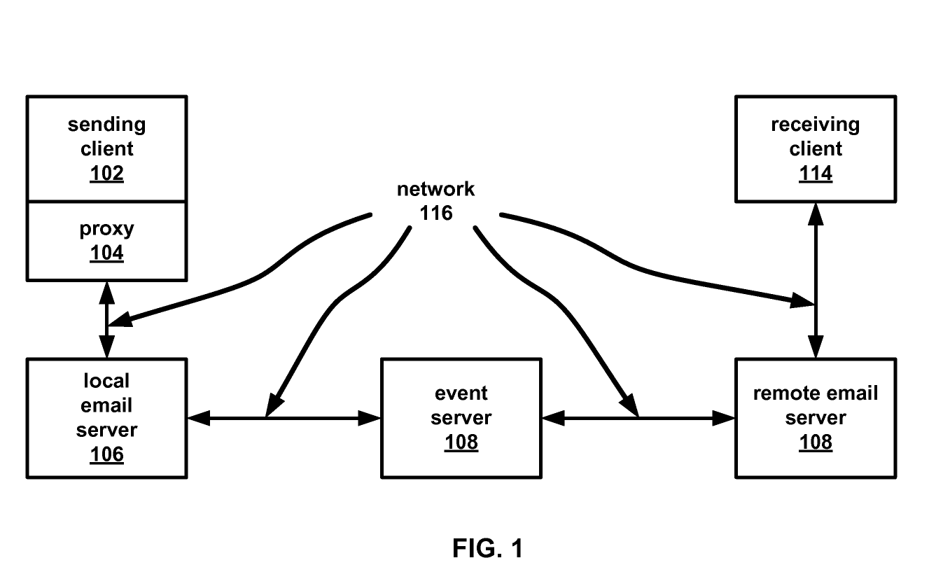

FIG. 1 illustrates an email transmission and revocation system according to an example embodiment.

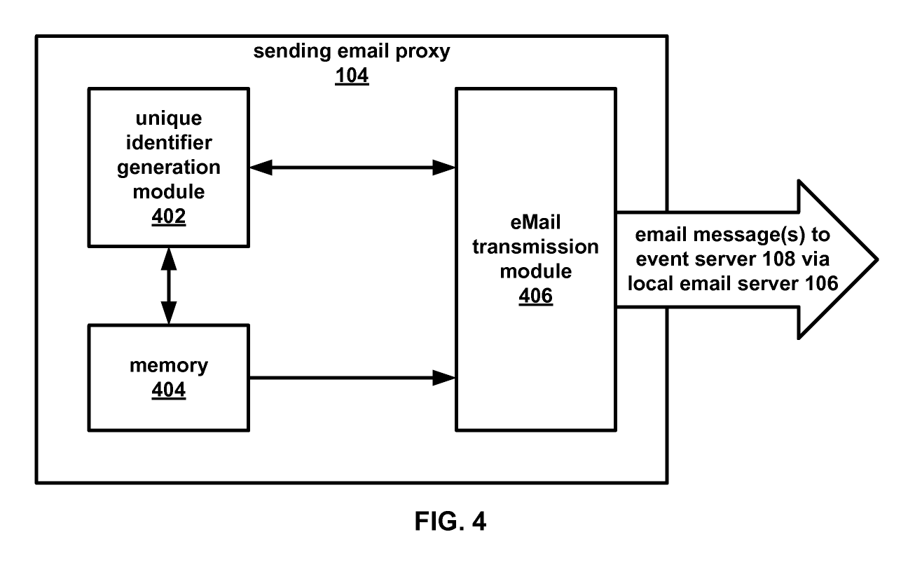

In the system shown in FIG. 1, a sending email proxy 104 is in two-communication with a local email server 106. The sending proxy 104 may be incorporated into a sending email client 102, or separate there from. The sending email client 102 may be a known email client including, but not limited to, Microsoft Outlook®, Microsoft Outlook Express®, Thunderbird email client, Mac Email, pine, and web email clients, etc. In the context of a web email client, the sending email client 102 and/or proxy 104 may run on the server side of the web email service implemented on a computer or other processing device. For the sake of clarity, the sending email proxy 104 will be described as being integrated with the sending email client 102. The sending proxy 104 is illustrated in more detail in FIG. 4.

Referring to FIG. 4, in an example embodiment, the sending email proxy 104 includes an email transmission module 406 configured to generate and transmit email messages. The email transmission module 406 communicates with a unique identifier generation module 402. The unique identifier generation module 402 is configured to generate a unique identifier based on email message generated by the email transmission module 406 and a key. The unique identifier may be a hash value, such as, SHA-1, SHA-2, RIPEMD-128, RIPEMD-160, or any other hash value generated according to any existing algorithm for regular or cryptographic hashes. Because signed hash values such as these are well-known.

Example embodiments may utilize the key to sign the hash value producing a signed hash value. The signed hash value is more computationally difficult to reproduce, thereby suppressing the likelihood that an attacker can revoke emails even if the attacker is able to obtain the hash value of the email.

The key may be unique for each user and may be generated in response to a registration process carried out by the user. The registration process may include providing user information, credit card information, etc. to the email revocation system (e.g., the event server 108) to obtain a username, password and an associated key to access the email revocation system described herein. Because registration processes are known, further discussion will be omitted.

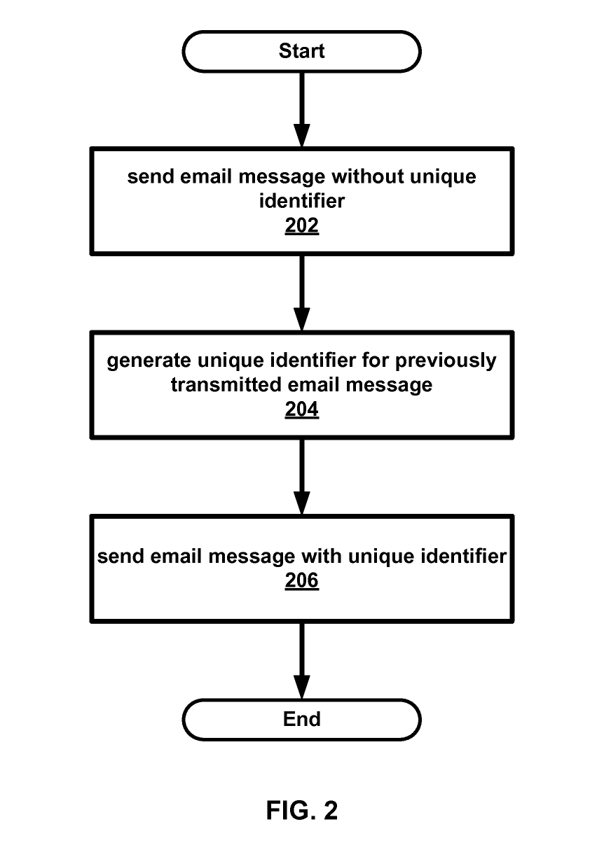

The sending email proxy 104 further includes a memory 404. The memory 404 may be any well-known internal or external memory. The memory 404 is configured to store email messages generated by the email transmission module 406 in association with unique identifiers generated by the unique identifier generation module 402. More specific functionality and operations will be described below with respect to the flow chart shown in FIG. 2.

Referring back to FIG. 1, the local email server 106 may be a known email server such as Sendmail, Qmail, Microsoft Email Server (IIS 6.0), etc. Because email servers are well-known in the art, a detailed discussion of the operations and functions of this network component will be omitted for the sake of brevity.

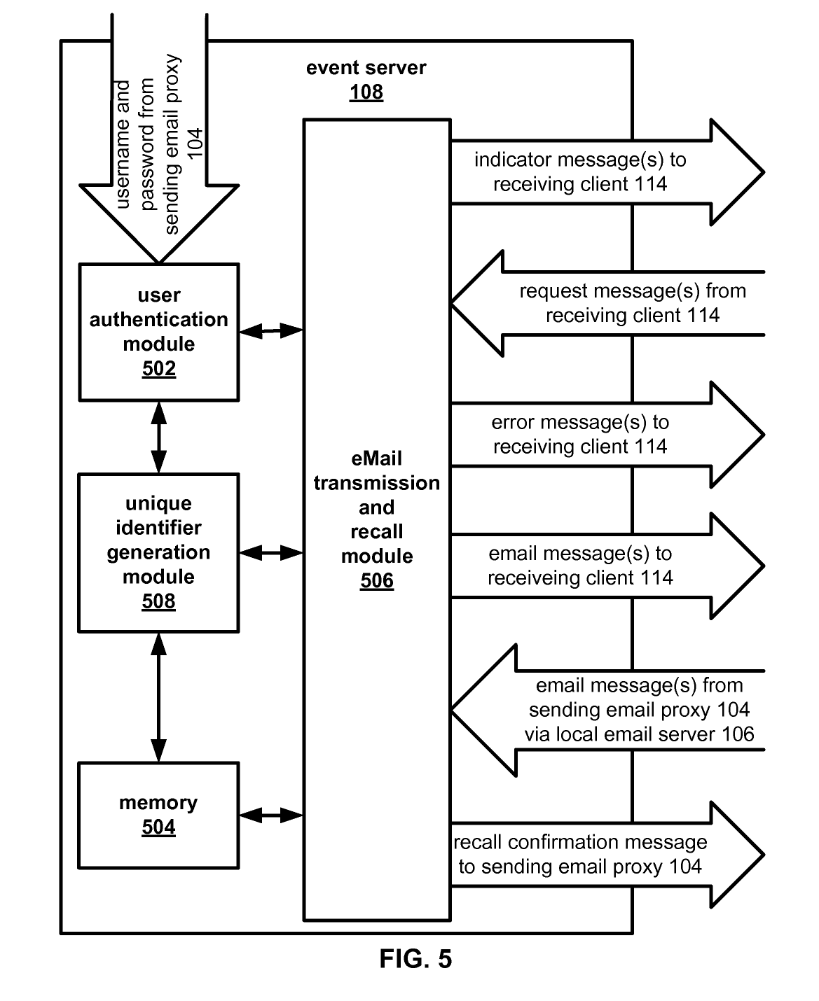

The local email server 106 is in two-way communication with an event server 108. The event server 108 facilitates transmission and revocation of email messages within the email transmission and revocation system shown in FIG. 1. An event server 108, according to an example embodiment, is shown in more detail in FIG. 5.

Referring to FIG. 5, in an example embodiment, the event server 108 includes an email transmission and recall module 506 in two-way communication with each of a user authentication module 502, a unique identifier generation module 508, and a memory 504. Each of the user authentication module 502 and the memory 504 are also in two-way communication with the unique identifier generation module 508

The unique identifier generation module 508 is configured to generate a unique identifier based on an email message received at the event server 108 and the above-described key, which may be known at the event server 108 or provided by the sending email proxy 104. Specifically, the unique identifier generation module 508 is configured to generate the same unique identifier as the unique identifier generation module 402 located at the sending email proxy 104. Again, the unique identifiers generated by the unique identifier generation module 508 may be signed hash values.

The memory 504 is configured to store received email messages in association with unique identifiers. The unique identifiers stored at the memory 504 may be received at the event server 108 or generated by the unique identifier generation module 508 as will be discussed in more detail below.

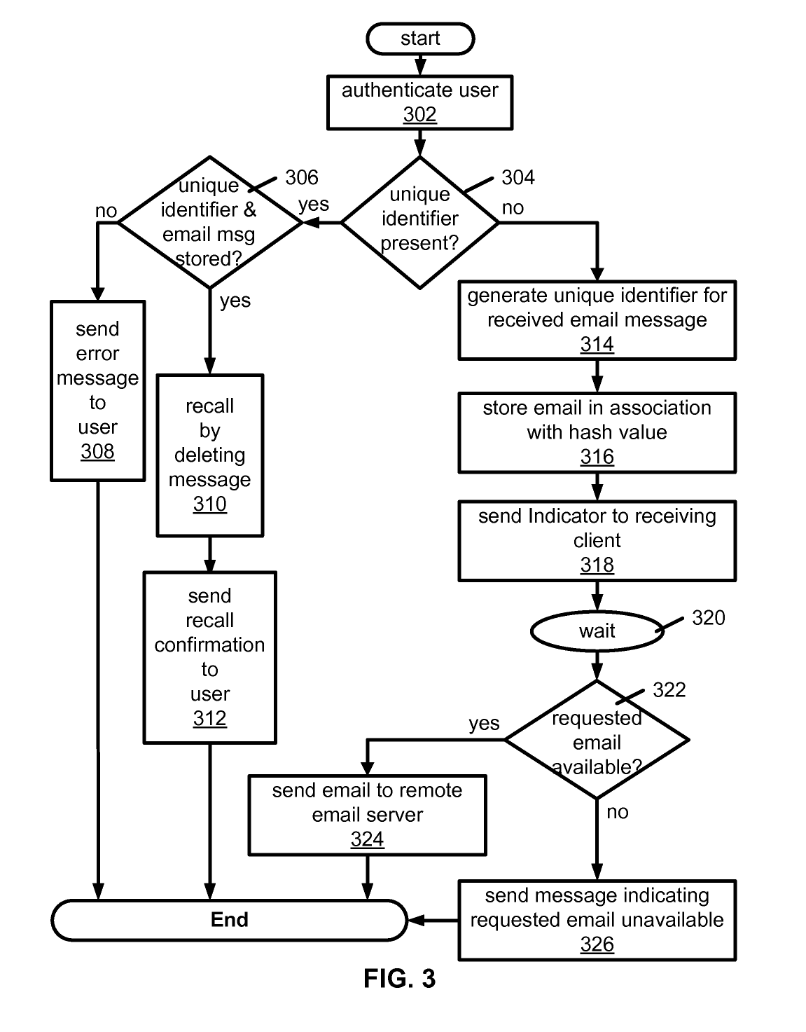

The user authentication module 502 is configured to authenticate users to transmit and recall email messages via the event server 108. More specific operations and functionality of the event server 108 will be described in more detail later with regard to the flow chart shown in FIG. 3.

Referring back to FIG. 1, the event server 108 also communicates with a remote email server 110, which further communicates with a receiving email client 114. The remote email server 110 may be a known remote email server such as Sendmail, Qmail, Microsoft Email Server (IIS 6.0), etc. The receiving email client 114 may be a known receiving email client including, but not limited to, Microsoft Outlook®, Microsoft Outlook Express®, Thunderbird email client, Mac Email, pine, web email clients, etc. As was the case with the sending email client 102, in the context of a web email client the receiving email client 114 may run on the server side of the web email service. Because remote email servers and receiving email clients are well-known in the art, a detailed discussion will be omitted.

A more detail discussion of example embodiments will be provided with respect to the flow charts shown in FIGS. 2 and 3. FIG. 2 is a flow chart illustrating a method for email transmission and revocation according to an example embodiment. The method shown in FIG. 2 may be performed at the sending email proxy 104 shown in FIGS. 1 and 4, and will be discussed as such for the sake of clarity.

FIG. 3 is a flow chart also illustrating a method for email transmission and revocation according to an example embodiment. The method shown in FIG. 3 may be performed at the event server 108 shown in FIGS. 1 and 5, and will be discussed as such for the sake of clarity.

Referring now to FIG. 2, after being authenticated by the event server 108 (which will be described in somewhat more detail later with regard to FIG. 3), the email transmission module 406 may generate and transmit one or more email messages to the event server 108 via email server 106 at action 202. Because these email messages have not been previously transmitted, the transmitted email message does not include a unique identifier. Each time an email message is transmitted, a copy of the transmitted email message is stored in the memory 404.

After transmitting an email message at action 202, the user at the sending email proxy 104 may recall the previously transmitted email message by causing the sending email proxy 104 to perform the actions 204 and 206 shown in FIG. 2. For example, if the user at sending email proxy 104 decides to recall the previously transmitted email message, the unique identifier generation module 402 generates a unique identifier (e.g., a signed hash value) based on the previously transmitted email message and the above-discussed key at action 204.

The unique identifier generation module 402 provides the generated unique identifier along with the previously transmitted email message to the email transmission module 406. At action 206, the email transmission module 406 transmits the previously transmitted email message along with the generated unique identifier to the event server 108 via the local email server 106 to recall the previously transmitted email message.

As noted above, FIG. 3 is a flow chart also illustrating an email transmission and revocation method according to an example embodiment. As also noted above, the method shown in FIG. 3 may be performed at the event server 108 shown in FIGS. 1 and 5, and will be discussed as such for the sake of clarity.

Referring to FIG. 3, at action 302 the user authentication module 502 authenticates the user at the sending email proxy 104. In one example, the user authentication module 502 authenticates the user based on a username and password provided by the sending email proxy 104. However, any suitable authentication method may be used. For example, the user may be authenticated using two-factor authentication (username/password), cryptographic token-based authentication, public-key certificates, etc.

After authenticating the user and having received a transmitted email message from the sending email proxy 104, the event server 108 determines whether a unique identifier (sometimes referred to herein as an “existing unique identifier”) is included with the received email message at action 304. The inclusion of an existing unique identifier with a received email message indicates to the event server 108 that the sending email proxy 104 desires recall or revocation of a previously transmitted email message.

If the received email message does not include a unique identifier (e.g., the received email message has not been previously transmitted), the unique identifier generation module 508 generates a unique identifier based on the received email message and the key associated with the user having transmitted the email message. As noted above, the key may be known at the event server 108 or received from the sending email proxy 104. The event server 108 then stores the generated unique identifier in association with the received email message at the memory 504.

Still referring to FIG. 3, at action 318 the email transmission and recall module 506 transmits an indicator message to the receiving email client 114. The indicator message may be in the form of a link or other message to a social website page (e.g., Facebook®, Twitter®, MySpace®), an instant message or other computer communication. The indicator message informs the receiver at the receiving email client 114 that there is an email pending for review, but may not reveal the sender or the content of the email. The event server 108 then enters a wait state at action 320.

While in the wait state, the event server 108 waits for a request message from the receiving email client 114 requesting retrieval and delivery of the transmitted email message. Upon receiving a request message from the receiving email client 114, the event server 108 checks the memory 504 to determine whether the requested email message is available at action 322.

According to example embodiments, each email message received at the event server 108 has an associated lifetime during which the receiving email client 114 is able to request delivery. Upon expiration of the lifetime of a received email message, the event server 108 deletes the received email message from the memory 504. Thus, the received email messages are only stored at the event server 108 for a limited amount of time. In addition or alternatively, the event server 108 may delete the stored email messages from the memory 504 in response to a subsequent transmission of the same email by the sending email proxy 104 as will be discussed in more detail later.

Still referring to action 322, if the requested email message is available at the event server 108, the email transmission and recall module 506 retrieves the email from the memory 504 and transmits the email message to the receiving email client 114 via the remote email client 110 at action 324.

Returning to action 322, if the requested email message has been deleted from the memory 504, the event server 108 sends an error message to the receiving email client 114. The error message indicates to the receiving email client 114 that the email message is no longer available and cannot be delivered.

Returning to action 304 in FIG. 3, if the received email message includes a unique identifier, the event server 108 checks whether the received email message and unique identifier are stored in the memory 504 at action 306. If the received email message and unique identifier are not stored in the memory 504, at action 308 the event server 108 returns an error message to the sending email proxy 104 indicating that the previously transmitted email message cannot be recalled or revoked.

Returning to action 306, if the received email message and unique identifier are stored in the memory 504, the event server 108 recalls the previously transmitted email message by deleting the email message and unique identifier from the memory 504 at action 310. At action 312, the event server 108 then sends a confirmation message to the sending email proxy 104 indicating that the previously transmitted email message has been recalled.

Example embodiments described herein provide methods, apparatuses and systems for transmitting an revoking email messages such that a sender can recall and inadvertently transmitted email message before the intended recipient is able to read the email message.

In this specification, “a” and “an” and similar phrases are to be interpreted as “at least one” and “one or more.”

Many of the elements described in the disclosed embodiments may be implemented as modules. A module is defined here as an isolatable element that performs a defined function and has a defined interface to other elements. The modules described in this disclosure may be implemented in hardware, software, firmware, wetware (i.e hardware with a biological element) or a combination thereof, all of which are behaviorally equivalent. For example, modules may be implemented as a software routine written in a computer language (such as C, C++, Fortran, Java, Basic, Matlab or the like) or a modeling/simulation program such as Simulink, Stateflow, GNU Octave, or LabVIEW MathScript. Additionally, it may be possible to implement modules using physical hardware that incorporates discrete or programmable analog, digital and/or quantum hardware. Examples of programmable hardware include: computers, microcontrollers, microprocessors, application-specific integrated circuits (ASICs); field programmable gate arrays (FPGAs); and complex programmable logic devices (CPLDs). Computers, microcontrollers and microprocessors are programmed using languages such as assembly, C, C++ or the like. FPGAs, ASICs and CPLDs are often programmed using hardware description languages (HDL) such as VHSIC hardware description language (VHDL) or Verilog that configure connections between internal hardware modules with lesser functionality on a programmable device. Finally, it needs to be emphasized that the above mentioned technologies are often used in combination to achieve the result of a functional module.

The disclosure of this patent document incorporates material which is subject to copyright protection. The copyright owner has no objection to the facsimile reproduction by anyone of the patent document or the patent disclosure, as it appears in the Patent and Trademark Office patent file or records, for the limited purposes required by law, but otherwise reserves all copyright rights whatsoever.

While various embodiments have been described above, it should be understood that they have been presented by way of example, and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments. Thus, the present embodiments should not be limited by any of the above described exemplary embodiments.

In addition, it should be understood that any figures which highlight the functionality and advantages, are presented for example purposes only. The disclosed architecture is sufficiently flexible and configurable, such that it may be utilized in ways other than that shown. For example, the steps listed in any flowchart may be re-ordered or only optionally used in some embodiments.

Further, the purpose of the Abstract of the Disclosure is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract of the Disclosure is not intended to be limiting as to the scope in any way.

Finally, it is the applicant's intent that only claims that include the express language “means for” or “step for” be interpreted under 35 U.S.C. 112, paragraph 6. Claims that do not expressly include the phrase “means for” or “step for” are not to be interpreted under 35 U.S.C. 112, paragraph 6.

What is claimed is:

1. A system for recalling at least one transmitted email message, the system comprising:
a. a local email proxy server configured to generate a unique identifier for the at least one previously transmitted email message, the unique identifier identifying the at least one transmitted email message and the sender of the at least one transmitted email message, the local email proxy server being further configured to send the at least one previously transmitted email message and the generated unique identifier to at least one event server;
b. at least one event server configured to check whether at least one received email message includes the generated unique identifier, determine whether the at least one received email message is stored in a memory at the at least one event server if the at least one received email message includes the generated unique identifier, and recall the at least one email message by deleting the email message if the at least one email message is stored in the memory at the at least one event server.

2. The computer readable storage medium of claim 1, wherein the unique identifier is a signed hash value for the transmitted email message.

3. A computer readable storage medium storing executable instructions that, when executed by one or more processors, causes the one or more processors to perform a method for recalling at least one previously transmitted email message, the method comprising:
a. generating, by a local email proxy server, a unique identifier for the at least one previously transmitted email message, the unique identifier identifying a sender of the at least one transmitted email message and indicating that the at least one previously transmitted email message has been previously transmitted; and
b. recalling, by the local email proxy server, the at least one previously transmitted email message by transmitting the at least one previously transmitted email message and the generated unique identifier to at least one event server at which the at least one previously transmitted email is stored.

4. The computer readable storage medium of claim 3, wherein the unique identifier is a signed hash value for the at least one previously transmitted email message.

5. The computer readable storage medium of claim 4, wherein the signed hash value is generated based on static information included in the at least one previously transmitted email message.

6. The computer readable storage medium of claim 4, wherein the at least one previously transmitted email message is first transmitted without the unique identifier.

7. A computer readable storage medium storing executable instructions that, when executed by one or more processors, causes the one or more processors to perform a method for recalling at least one transmitted email message, the method comprising:
a. receiving at least one transmitted email message at least one event server;
b. checking, by the at least one event server, whether the at least one received email message includes an existing unique identifier;
c. determining, by the at least one event server, whether the at least one received email message is stored at the at least one event server if the at least one received email message includes the existing unique identifier; and
d. recalling the at least one transmitted email message by deleting the at least one transmitted email message from the at least one event server if the at least one received email message is stored at the at least one event server.

8. The computer readable storage medium of claim 7, further comprising sending a recall confirmation to a user requesting recall of the at least one transmitted email message.

9. The computer readable storage medium of claim 7, further comprising sending an error message from the at least one event server to a user requesting recall of the at least one transmitted email message if the at least one event server determines that the at least one received email message is not stored at the at least one event server.

10. The computer readable storage medium of claim 7, further comprising authenticating, by the at least one event server, a user to recall the at least one transmitted email message in response to an identification key received from the user.

11. The computer readable storage medium of claim 10, further comprising:
a. generating a unique identifier for the at least one received email message based on the identification key if the at least one received email message does not include the existing unique identifier;
b. storing the at least one received email message in association with the generated unique identifier; and
c. sending at least one received email indicator message including a trigger event to at least one intended email recipient, the at least one received email message indicator informing the at least one intended email recipient that at least one email message has been received at the at least one event server.

12. The computer readable storage medium of claim 11, further comprising:
a. determining, by the at least one event server, whether the at least one received email message has been recalled in response to a request from the at least one intended email recipient; and
b. sending the at least one received email message to the at least one intended email recipient if the at least one event server determines that the at least one received email message has not been recalled.

13. The computer readable storage medium of claim 12, further comprising sending at least one message recalled indicator message to the at least one intended email recipient if the at least one event server determines that the at least one received email message has been recalled, the at least one message recalled indicator message indicating that the at least one received email message has been recalled.

14. The computer readable storage medium of claim 1, wherein the unique identifier is a signed hash value for the transmitted email message.

15. A computer readable storage medium storing executable instructions that, when executed by one or more processors, causes the one or more processors to perform a method for email transmission in a network, the method comprising:
a. authenticating, by at least one event server, a user to transmit at least one email message via the at least one event server in response to an identification key received from the user;
b. determining, by the at least one event server, whether at least one received email message includes an existing unique identifier;
c. generating, by the at least one event server, at least one unique identifier for the at least one received email message based on the identification key if the at least one received email message does not include an existing unique identifier;
d. storing, at the at least one event server, the at least one received email message in association with the generated unique identifier; and
e. sending, by the at least one event server, at least one indicator message to at least one intended email recipient including a trigger event, the at least one indicator message informing the at least one email recipient that at least one email message has been received at the at least one event server.

16. The computer readable storage medium of claim 15, further comprising sending the at least one received email message to the at least one email recipient after expiration of a recall timer associated with the at least one received email message.

17. The computer readable storage medium of claim 15, further comprising:
a. determining whether the at least one received email message is stored at the at least one event server in response to a request from the at least one email recipient; and
b. sending the at least one received email message to the at least one email recipient if the at least one received email message is stored at the at least one event server.

18. The computer readable storage medium of claim 15, further comprising:
a. determining whether the at least one received email message is stored at the at least one event server in response to a request from the at least one email recipient; and
b. sending a recall indication message to the at least one email recipient if the at least one received email message is not stored at the at least one event server.

19. The computer readable storage medium of claim 15, further comprising deleting the at least one stored email message in response to a subsequent receipt of the at least one received email message and the generated unique identifier from the user.

20. The computer readable storage medium of claim 1, wherein the unique identifier is a signed hash value for the received email message.
